(19) United States
(12) Patent Application Publication
(10) Pub. No.: US 2008/0317987 A1
(43) Pub. Date: Dec. 25, 2008

(54) Nanocomposite materials for ethanol, methanol and hydrocarbon transportation use and storage

(76) Inventors: David Abecassis, Huntington, NY (US); Ed Wiegel, Baltimore, MD (US); Bosley Wright, Owings Mills, MD (US)

Correspondence Address: Thomas A. O'Rourke;Bonder & O'Rourke, 425 Boardhollow Road, Melville, NY, 11747, US

(21) Appl. No.: 12/152,455

(22) Filed: May 14, 2008

Related U.S. Application Data
(63) Continuation-in-part of application No. 11/880,888, filed on Jul. 23, 2007.
Application No. 11/880,888 is a continuation-in-part of application No. 11/645,093, filed on Dec. 22, 2006.
(60) Provisional application No. 60/930,086, filed on May 14, 2007.
(60) Provisional application No. 60/832,337, filed on Jul. 21, 2006.

(51) Int. Cl. C08K 3/36; B29D 22/00

(52) U.S. Cl. 428/36.4; 524/445

(57) ABSTRACT

Alcohol and ester resistant thermoplastic blends are described. The blends include a clay and a triphenyl phosphate or a diphosphate nanocomposite blended with the thermoplastic.

This application claims priority on U.S. Provisional Patent Application Ser. No. 60/930,086, filed on May 14, 2007, the disclosures of which are incorporated herein by reference.

This application is a continuation in part of U.S. patent application Ser. No. 11/880,888, filed Jul. 23, 2007, which claims priority on U.S. Provisional Patent Application Ser. No. 60/832,337, filed Jul. 21, 2006, and a continuation in part of U.S. application Ser. No. 11/645,093, filed Dec. 22, 2006. The disclosures of each of such applications are incorporated herein by reference.

### FIELD OF THE INVENTION

The invention relates to the field of improved nanocomposite thermoplastic blends with exfoliated clays. More particularly, the present invention is directed to materials appropriate for use in ethanol, methanol and hydrocarbon transportation and storage.

### BACKGROUND OF THE INVENTION

In an economic environment of rising prices for petroleum based hydrocarbon fuels, the use of biologically derived alcohols and hydrocarbons will increase in importance. Ethanol, methanol and bio-diesel precursors, the most common substitutes or additives for hydrocarbon based fuels, all contain oxygen in their molecular structures. The presence of the oxygen renders these compounds more polar than traditional hydrocarbon fuels that they are mixed with. As a result, these compounds tend to be more water miscible. Ethanol and methanol are common bio-fuels which are susceptible to moisture absorption. The tendency of alcohol based biofuels to absorb water creates issues not present with hydrocarbon based fuels. Existing hydrocarbon based infrastructure is designed for the use of petroleum based hydrocarbons where water is not present in significant amounts and not polar water containing miscible compounds.

Hydrocarbons are typically water repellent and do not spontaneously absorb moisture. As the use of oxygenated alcohols and other bio-fuels increases, the existing infrastructure for fuel transport and storage may encounter problems from the use of, for example, alcohols and esters. This, in place infrastructure, was designed for petroleum hydrocarbons and has proven to be inadequate when water is present due to the infrastructure's susceptibility to corrosion and stress cracking.

Water being a polar compound is very susceptible to being absorbed into polar alcohols. In addition, water can degrade into hydronium ions and hydroxide ions. Hydronium ions are also called protons in the absence of water. By reacting with H+ ions, ferrous metals give up electrons and corrode and can undergo stress cracking as well.

Because of these properties of alcohols, the existing ferrous metal infrastructure for transporting and storing hydrocarbon based fuel is not adapted to the transport and storage of alcohols and bio-fuels which are prone to moisture absorption. Since the cost associated with the transport of hydrocarbon fuels is significant particularly in an era of increasing fuel costs, the use of pipelines instead of vehicle transport can save 70% of the transportation costs associate with fuel.

Storage vessels are also affected by the presence of water in the alcohols that can be blended with hydrocarbon fuels since these vessels may also contain ferrous metals and these are expensive to install and replace. The compositions of the present invention have enhanced barrier and chemical resistance properties. As a result, infrastructure using the composition of the present invention reduces the risk that alcohol based compositions containing water will damage ferrous based transport and storage equipment.

Non nanocomposite polymers such as Teflon and polypropylene are traditionally resistant to degradation and attack from alcohols and oxygenated fuels but unfortunately lack the necessary mechanical properties of ferrous metals whose strength are orders of magnitude higher and more appropriate to load bearing structural roles. In many pipeline and storage applications therefore, the usual application of polymers such as Teflon and polypropylene, is in such uses as liners and protective materials. As liners and protective materials, Teflon and polypropylene's mechanical properties will not affect the application. While polymer based materials such as polypropylene and Teflon (fluoropolymers) have been used for seals and liners, these materials are not appropriate in applications where elastomeric tubing is required. Where materials such as EPDM rubber are used, these elastomers are more readily attacked in the presence of alcohols.

Commercially, in the United States, ethanol is often mixed with conventional hydrocarbon fuels but these blends interact with storage materials. Domestic gasoline is often mixed with ethanol to form a blend referred to as E-85. The use of E-85 has been subject to some regulation. For example, Illinois' administrative rules [41 Ill. Adm. Code 170.470 & 170.630] require UST systems to be compatible with the product stored.

Components and equipment used for storing/dispensing conventional fuels are time tested for compatibility and readily available through a petroleum supplier. High percentages of ethanol, however, do not have the same compatibility characteristics of conventional fuels when it comes to storage and dispensing. Soft metals such as zinc, brass or aluminum, which are commonly found in conventional fuel storage and dispensing systems, are not compatible with E85. Steel tanks and piping must be UL listed or certified by the manufacturer with no indications of internal corrosion. Some nonmetallic materials may also degrade when in contact with ethanol. These non metallic materials can include natural rubber, polyurethane, certain adhesives (used in older fiberglass piping), certain elastomers and polymers used in flex piping, bushings, gaskets, meters, filters, and materials made of cork. In order to store and dispense high percent ethanol, fiberglass and steel UST systems/components must be listed by Underwriters Laboratories, Inc., or certified by the manufacturer.

Corrosion of materials containing ethanol blends creates potential for environmental hazard since systems such as underground storage tanks can release hydrocarbon/ethanol blends into soil and groundwater. The release of existing hydrocarbon varieties into soil and water is responsible for billions of dollars worth of environmental clean up liability in individual states alone where contamination is at relatively moderate levels by national standards. Highly contaminated states have accumulated so much pollution from conventional fuel contamination that a map with superfund sites marked as dots literally blackens significant portions of the state map.

The increased use of alcohol based additives such as ethanol with hydrocarbons only increases the probability of greater environmental contamination, especially with existing aging hydrocarbon infrastructure.

### OBJECTS OF THE INVENTION

It is an object of the invention to provide compositions useful in storage and handling equipment.

It is also an object of the invention to provide compositions for use in the transporting and storing of alcohol containing hydrocarbons.

It is a further object of the invention to provide clay based nanocomposites that are useful in applications where there is contact with alcohol and ester based materials.

It is a still further object of the invention to provide clay based nanocomposites that have superior barrier and chemical resistance properties that make them suitable for use in storing and transporting fuel based hydrocarbons containing alcohols and/or esters.

It is a still further object of the invention is to develop new materials more appropriate for use in handling and storing alcohol and ester containing bio-fuels.

It is still another object of the invention to provide clay based nanocomposites that can be blended with thermoplastics to form a variety of products that are used in an alcohol or ester environment.

### SUMMARY OF THE INVENTION

The invention is directed to clay based blends with triphenyl phosphate and alkylated derivatives of triphenyl phosphate. The present invention is also directed to clay based blends of bis-phenol diphosphate (BDP), resorcinol diphosphate (RDP) and bis(3-T-Butyl-4 hydroxyphenyl-2,4 Di-T-butylphenyl) resorcinol diphosphate and their hydroxyl-derived ethers, esters, and amides where aliphatic fatty acids are added to the molecule. The clays useful in the present invention can be a smectite clay which is a naturally occurring clay material selected from the group including hectorite, montmorillonite, bentonite, beidelite, saporite, stevensite and mixtures thereof. The clay can also be a kaolin based clay. The clay blends of a phosphate and clay are further blended with a thermoplastic to form a nanocomposite. These clay additives surface treat smectite and kaolin based clays to create nanocomposite materials, which when blended with thermoplastics are more resistant to contact with ethanol, methanol, and bio-diesel containing fuels by providing enhanced barrier and chemical stability associated with clay based nanocomposites.

The blends of the present invention have particular application in the formation of storage vessels, pipelines, as well as liners used where alcohol and ester based products are present. The composition of the present invention may also be used in seals and gaskets, valves and other types of equipment used in connection with hydrocarbon fuels containing an alcohol or ester that would corrode if made from a ferrous metal.

### DETAILED DESCRIPTION OF THE INVENTION

The blends of the present invention are made up of a phosphate based organo-compound, these compounds include triphenyl phosphate and alkylated derivatives of triphenyl phosphate as well as bis-phenol diphosphate (BDP), resorcinol diphosphate (RDP) and bis (3-T-Butyl-4 hydroxyphenyl-2,4 Di-T-butylphenyl) resorcinol diphosphate and their hydroxyl-derived ethers, esters, and amides where aliphatic fatty acids are added to the molecule. These phosphate based compounds are blended with smectites or kaolin based clays. The smectite based clays can include naturally occurring clay material selected from the group including hectorite, montmorillonite, bentonite, beidelite, saporite, stevensite and mixtures thereof. The clay can also be a kaolin based clay. The clay blends of a phosphate and clay are further blended with a thermoplastic to form a nanocomposite. The blend of clay and phosphate compound is preferably from about 1% to about 10% by weight phosphate compound and 90 to about 99% by weight clay. In a more preferred embodiment, there is about 3% to about 8% by weight phosphate compound and about 92% to about 98% clay. In a most preferred embodiment, there is about 4% to about 6% phosphate compound and about 94% to 96% clay.

The clay blend so formed from clay and the phosphate is blended with a thermoplastic material. The thermoplastic material can include but is not limited to any suitable olefin based thermoplastic material. Suitable thermoplastics include polypropylene (PP), polyethylene (PE), polyvinylidene chloride (PVC), rigid or flexible elastomeric polyolefin (EPDM rubber), polyphenylene sulfide (PPS), polybutylene (PB), ionomer, polyetherether-ketones (PEEK), acetyl butyl styrene (ABS), copolymer and fluorocopolymers such as Teflon, ethylene vinyl alcohol (EVOH), polyamide, polymide or silicone polymer. The clay blend makes up about 1% to about 20% of the blend with the balance thermoplastic. In a more preferred embodiment, the clay blend is from about 3% to about 17% clay blend with the balance thermoplastic. In a most preferred embodiment, there is about 5% to about 15% clay blend with the balance thermoplastic.

In making the blends of the present invention, one preferred method is to surface treat the clay with the phosphate containing compound. This is preferably performed in one unit operation; dry-blending, with the surface treatment. In many cases, this surface treatment can be enhanced by fluidizing the clay particles through vibration or shear where, due to their small particle size, the clay particles act as a pseudo-fluid, and then the liquid is added by adsorption.

The surface treated clay is then used as a plastics additive where it is compounded into the thermoplastic polymer via high sheer single screw, or conventional twin-screw extrusion and pelletization.

### EXAMPLE

ABS was processed in a 33 mm Wernerer Pfleiderer twin screw extruder. The control pure ABS material was extruded to induce similar porosity in the resin. The beads were collected. Then the same ABS was extruded with 5% w/w RDP organoclay. Both samples were placed in 30 ml scintillation vials in the presence of pure anhydrous ethanol.

The swell rate for the control ABS was 7% w/w over 24 hours whereas the nanocomposite exhibited less than 3% swell rate during the same period. Since some of the swell value can be attributed to surface porosity which is estimated by microscopy at 2%; the adjusted swell rate during 24 hours is corrected to 5% and 1% respectively.

Conclusions: The nanocomposite material is a better ethanol contact material than its' non-organoclay filled control.

What is claimed:

1. A vessel for transporting alcohol and esters containing fluids, said vessel comprising a blend of a thermoplastic and nanocomposite, said nanocomposite comprising a clay and a phosphate based compound selected from the group consisting of a triphenyl phosphate and alkylated derivatives thereof, bis-phenol diphosphate (BDP), resorcinol diphosphate (RDP), bis (3-T-Butyl-4 hydroxyphenyl-2,4 Di-T-butyl phenyl), resorcinol diphosphate and hydroxyl derived esters, ethers and amides where aliphatic fatty acids are added to the molecule.

2. The vessel according to claim 1 wherein said clay is selected from the group of smectite clays and kaolin clays.

3. The vessel according to claim 2 wherein said phosphate comprises about 1% to about 10% and the clay comprises about 90% to about 99% by weight of the nanocomposite.

4. The vessel according to claim 3 wherein said thermoplastic comprises 80% to 99% of the blend.

5. The vessel according to claim 4 wherein the thermoplastic is selected from the group consisting of polypropylene (PP), polyethylene (PE), polyvinylidene chloride (PVC), rigid or flexible elastomeric polyolefin (EPDM rubber), polyphenylene sulfide (PPS), polybutylene (PB), ionomer, polyetherether-ketones (PEEK), acetyl butyl styrene (ABS), copolymer and fluorocopolymers such as Teflon, ethylene vinyl alcohol (EVOH), polyamide, polymide or silicone polymer.

6. The vessel according to claim 4 wherein the vessel is a hose.

7. The vessel according to claim 4 wherein the vessel is a storage tank liner.

8. The vessel according to claim 4 wherein the vessel is a storage drum.

9. The vessel according to claim 4 wherein the vessel is a rail car tank liner.

10. The vessel according to claim 4 wherein the vessel is a fuel tank.

11. A gasket for use in applications where said gasket contacts an alcohol or an ester containing fluid, said gasket comprising a blend of a thermoplastic and nanocomposite, said nanocomposite comprising a clay and a phosphate based compound selected from the group consisting of a triphenyl phosphate and alkylated derivatives thereof, bis-phenol diphosphate (BDP), resorcinol diphosphate (RDP), bis (3-T-Butyl-4 hydroxyphenyl-2,4 Di-T-butyl phenyl), resorcinol diphosphate and hydroxyl derived esters, ethers and amides where aliphatic fatty acids are added to the molecule.

12. A valve for use in applications where said valve contacts an alcohol or an ester containing fluid, said valve comprising a blend of a thermoplastic and nanocomposite, said nanocomposite comprising a clay and a phosphate based compound selected from the group consisting of a triphenyl phosphate and alkylated derivatives thereof, bis-phenol diphosphate (BDP), resorcinol diphosphate (RDP), bis (3-T-Butyl-4 hydroxyphenyl-2,4 Di-T-butyl phenyl), resorcinol diphosphate and hydroxyl derived esters, ethers and amides where aliphatic fatty acids are added to the molecule.

13. A pump component where said pump component contacts an alcohol or an ester containing fluid, said pump component comprising a blend of a thermoplastic and nanocomposite, said nanocomposite comprising a clay and a phosphate based compound selected from the group consisting of a triphenyl phosphate and alkylated derivatives thereof, bis-phenol diphosphate (BDP), resorcinol diphosphate (RDP), bis (3-T-Butyl-4 hydroxyphenyl-2,4 Di-T-butyl phenyl), resorcinol diphosphate and hydroxyl derived esters, ethers and amides where aliphatic fatty acids are added to the molecule.

14. A turbine blade where said turbine blade contacts an alcohol or an ester containing fluid, said turbine blade comprising a blend of a thermoplastic and nanocomposite, said nanocomposite comprising a clay and a phosphate based compound selected from the group consisting of a triphenyl phosphate and alkylated derivatives thereof, bis-phenol diphosphate (BDP), resorcinol diphosphate (RDP), bis (3-T-Butyl-4 hydroxyphenyl-2,4 Di-T-butyl phenyl), resorcinol diphosphate and hydroxyl derived esters, ethers and amides where aliphatic fatty acids are added to the molecule.

15. A transfer pump component where said transfer pump component contacts an alcohol or an ester containing fluid, said transfer pump component comprising a blend of a thermoplastic and nanocomposite, said nanocomposite comprising a clay and a phosphate based compound selected from the group consisting of a triphenyl phosphate and alkylated derivatives thereof, bis-phenol diphosphate (BDP), resorcinol diphosphate (RDP), bis (3-T-Butyl-4 hydroxyphenyl-2,4 Di-T-butyl phenyl), resorcinol diphosphate and hydroxyl derived esters, ethers and amides where aliphatic fatty acids are added to the molecule.

16. A cap for sealing a vessel wherein said cap contacts an alcohol or an ester containing fluid, said cap comprising a blend of a thermoplastic and a blend of a thermoplastic and nanocomposite, said nanocomposite comprising a clay and a phosphate based compound selected from the group consisting of a triphenyl phosphate and alkylated derivatives thereof, bis-phenol diphosphate (BDP), resorcinol diphosphate (RDP), bis (3-T-Butyl-4 hydroxyphenyl-2,4 Di-T-butyl phenyl), resorcinol diphosphate and hydroxyl derived esters, ethers and amides where aliphatic fatty acids are added to the molecule.

17. A spout for a vessel wherein said spout contacts an alcohol or an ester containing fluid, said spout comprising a blend of a thermoplastic and nanocomposite, said nanocomposite comprising a clay and a phosphate based compound selected from the group consisting of a triphenyl phosphate and alkylated derivatives thereof, bis-phenol diphosphate (BDP), resorcinol diphosphate (RDP), bis (3-T-Butyl-4 hydroxyphenyl-2,4 Di-T-butyl phenyl), resorcinol diphosphate and hydroxyl derived esters, ethers and amides where aliphatic fatty acids are added to the molecule.

18. A flooring material wherein said flooring material contacts an alcohol or an ester containing fluid, said flooring material comprising a blend of a thermoplastic and nanocomposite, said nanocomposite comprising a clay and a phosphate based compound selected from the group consisting of a triphenyl phosphate and alkylated derivatives thereof, bis-phenol diphosphate (BDP), resorcinol diphosphate (RDP), bis (3-T-Butyl-4 hydroxyphenyl-2,4 Di-T-butyl phenyl), resorcinol diphosphate and hydroxyl derived esters, ethers and amides where aliphatic fatty acids are added to the molecule.

19. An article, said article contacting an alcohol or an ester containing fluid, said article comprising a blend of a thermoplastic and nanocomposite, said nanocomposite comprising a clay and a phosphate based compound selected from the group consisting of a triphenyl phosphate and alkylated derivatives thereof, bis-phenol diphosphate (BDP), resorcinol diphosphate (RDP), bis (3-T-Butyl-4 hydroxyphenyl-2,4 Di-T-butyl phenyl), resorcinol diphosphate and hydroxyl derived esters, ethers and amides where aliphatic fatty acids are added to the molecule.
